(19) United States
(12) Patent Application Publication
(10) Pub. No.: US 2017/0321652 A1
(43) Pub. Date: Nov. 9, 2017

(54) DESIGN OF A WIND TURBINE

(71) Applicant: Wobben Properties GmbH, Aurich (DE)

(72) Inventors: Alfred BEEKMANN, Wiesmoor (DE); Marcel KRUSE, Beverstedt (DE)

(21) Appl. No.: 15/526,182

(22) PCT Filed: Oct. 23, 2015
(86) PCT No.: PCT/EP2015/074589

§ 371 Date: May 11, 2017

(30) Foreign Application Priority Data
Nov. 19, 2014 (DE) 10 2014 223 640.1

(51) Int. Cl. F03D 7/02; F03D 9/25; F03D 7/04; F03D 9/11; F03D 1/06; F03D 13/20

(52) U.S. Cl. CPC F03D 7/0204; F03D 1/0666; F03D 9/25; F03D 7/048; F03D 7/042; F03D 9/11; F03D 13/20; F05B 2270/32

(57) ABSTRACT

A method for designing a wind energy plant with a generator and with a rotor with rotor blades, comprising the steps determining the size of the wind energy plant which is to be designed, more particularly the rotor diameter and axle height, for a proposed installation site, designing the wind energy plant for a reduced maximum load which is lower than a maximum load which occurs when a 50-year gust strikes the wind energy plant from a maximum loading side.

### BACKGROUND

### Technical Field

The present invention relates to a method for designing a wind energy plant as well as to a corresponding wind energy plant. The invention further relates to the operation of a wind energy plant. The invention also relates to a wind farm with several wind energy plants as well as to a method for operating one such wind farm.

### Description of the Related Art

Wind energy plants are generally known and they generate electric current from wind energy. Wind energy plants can be classified quite roughly in terms of their nominal output and wind site, thus according to how strong the wind is from experience at the planned site of the wind energy plant. The wind energy plant is furthermore to be designed so that it withstands a so-called 50-year gust. The idea here is that statistically every 50 years a gust of wind occurs which is so strong that the wind energy plant can be mechanically endangered or even destroyed. The wind energy plant must thus be able to withstand one such gust of wind without being destroyed or suffering noticeable damage.

In order to protect a wind energy plant against storm damage it is already known to switch off wind energy plants in the event of very high wind speeds and before this to bring the rotor blades into a so-called feathered position. The wind energy plant is thus in such a situation no longer in operation and is thereby better able to withstand strong winds. This also includes when charged by a 50-year gust.

A storm situation and more particularly a 50-year gust which occurs can equally exert very strong forces on components of the wind energy plant. In addition to the high wind speed of a 50-year gust of this type there is also the problem that this can occur unforeseen and even suddenly. A 50-year gust is not to be anticipated in the event of a lull in the wind or a slight wind, but is to be anticipated in the event of storm-force wind speeds. If a 50-year gust is basically to be expected, it is nevertheless however not possible to foresee whether one will or will not shortly be occurring.

As a result the wind energy plant has to be designed correspondingly stable, namely mechanically stable. The parts which are particularly critical or susceptible to such strain are the tower of the wind energy plant, the rotor blades, a machine support for supporting the components including the generator and thus the aerodynamic rotor, if in each case a gearless wind energy plant is used, and the foundation of the wind energy plant.

Thus very high costs can accordingly arise in that the wind energy plant has to be designed for this one occurrence which seen statistically arises once every 50 years. More particularly the components mentioned above which can be particularly vulnerable have to be designed accordingly, which can be correspondingly expensive.

It is thus to be taken into account, particularly in the case of a correspondingly resistant design of the rotor blades, that this will require a certain material use and thus a certain weight. Such high weight of the rotor blades is again to be considered accordingly through the machine support and/or bearing of the rotor blades. These elements then likewise have to be made with larger dimensions. This also applies for other elements and ultimately the foundation has to take up all these weights and at the same time take up the corresponding wind load.

### BRIEF SUMMARY

One or more embodiments are directed to reducing the expense which arises by taking into consideration a 50-year gust. At least one alternative solution is to be proposed in respect of the solutions known up until now.

In accordance with the invention a method is proposed. According to this a wind energy plant is designed which has at least one generator and one aerodynamic rotor with rotor blades. At first the size of the wind energy plant which is to be designed is fundamentally determined for a proposed installation site. This relates in particular to pre-setting the rotor diameter and the axle height of the rotor. This originates here from a horizontal axle rotor. The present invention furthermore basically stems from a rotor with three rotor blades wherein the idea of the invention is however not restricted to this. The rotor diameter relates to the circle which the rotor blades form when the wind energy plant in operation.

The wind energy plant thus determined from the first basic data is now designed to withstand a reduced maximum load, namely to a load which is lower than a maximum load which occurs when a 50-year gust strikes the wind energy plant from a maximum loaded side.

It was here initially recognized that the wind energy plant has indeed to be designed for a 50-year gust, that the wind energy plant thus has to withstand a 50-year gust, but that it is not absolutely necessary to withstand a 50-year gust from each and every direction.

This is also based on the idea that the occurrence of a 50-year gust can scarcely be foreseen, but that the direction from which one such 50-year gust could appear is however more or less known. Namely one such 50-year gust occurs in conjunction with the already existing high wind speeds. And in the case of high wind speeds in spite of turbulences the approximate direction of the wind speed and thus the approximate direction from which the 50-year gust could appear, are each more or less known, namely from the direction from which the wind is coming at that moment.

It is thus now possible to design the wind energy plant weaker than would be necessary for withstanding a 50-year gust from every direction.

The design for one such reduced maximum load can then be particularly expedient if at least it is ensured that a 50-year gust does not strike the wind energy plant from a maximum loaded side.

The wind energy plant is preferably designed for a reduced maximum load which occurs when the 50-year gust strikes the wind energy plant from a direction which does not lead to the maximum load. It is particularly advantageous to design for a reduced maximum load which occurs when the 50-year gust strikes the wind energy plant from a direction which leads to the smallest load.

In the case of the maximum occurring load this depends on the position of the rotor blades. If the rotor blades are in the feathered position, which is a standard position in the case of very high wind speeds, then by way of example a gust appearing laterally on the nacelle of the wind energy plant can lead to a high, perhaps the highest load.

The reduced minimum load is preferably a load which occurs when the 50-year gust strikes the wind energy plant from the front, particularly when the rotor blades are in the feathered position. The gust then has a small attack area on the rotor blades. Furthermore the rotor blades thereby have their front edge facing the wind or the gust, and their rear edge facing in the opposite direction and the rotor blade is particularly rigid in such alignment, namely from the front edge to the rear edge. The rotor blades thus in this case only offer very little attack area with a simultaneously high stability in this attack direction.

However the appearance of the gust on the wind energy plant nacelle from the front also leads to a lower load than in the case where a gust occurs laterally on the nacelle of the wind energy plant, because the nacelle offers more attack surface at the side than from the front. The design of the nacelle is furthermore mainly set up for wind from the front.

The wind energy plant would thus be designed correspondingly for the load which occurs when a 50-year gust strikes the wind energy plant from the front with rotor blades in the feathered position. If the design is undertaken for this situation then a weaker design can be adopted than when the gust strikes from any one side, or from any one direction, more particularly from the side. The components can now thus be designed weaker which can lead to savings at various places. Apart from the basic potential to make material savings it is even possible where applicable to include the transport and also size and lifting capacity of the crane for setting up the wind energy plant.

The reduced maximum load is preferably one which occurs when the 50-year gust strikes the wind energy plant from the front from a sector which is more particularly termed a region ±20° from the front. In this case it is thus proposed to design the wind energy plant for a load which in the case of a 50-year gust can appear from this front sector. A reduced design is hereby possible, but at the same time a certain tolerance remains for the possible impact direction of the wind gust from the front. The wind energy plant is then designed more slender than for wind gusts from any direction, but at the same time is not restricted to precisely one impact direction.

A thus slender designed wind energy plant ought as a consequence then also to be later operated so that one such 50-year gust strikes the wind energy plant only from the region for which the plant was thus designed. A practical compromise was thus found by determining one such sector from the front, more particularly over this region of ±20.

The design of the wind energy plant preferably relates to the reduced maximum load comprising at least one of the components from the list:
a nacelle for housing the generator,
a tower for supporting the nacelle,
a tower foundation for supporting the tower, and
the rotor blades.

According to the invention a method is proposed. According to this a method is proposed for operating a wind energy plant. This method presupposes initially a wind energy plant which is fitted with an azimuth adjustment in order to align the wind energy plant to the wind during operation. Furthermore the wind energy plant is fitted with adjustable rotor blades in order to set the rotor blades to the prevailing wind speed and where applicable to rotate them in the wind. This operation of the wind energy plant is thus understood to be the alignment of the wind energy plant and the wind energy plant hereby often generates no more current. Insofar as the wind conditions—and other conditions—again permit it, the wind energy plant is however also operated again so that it generates current.

The method now proposes in the event of a storm when the occurrence of a 50-year gust cannot be ruled out, or more particularly if the occurrence of a 50-year gust is probable, to align the wind energy plant in its azimuth position into the wind so that a 50-year gust coming from the prevailing wind direction only leads to the reduced maximum load.

It is thus proposed to align the wind energy plant towards the prevailing wind even in the event of storm, thus irrespective of whether the wind energy plant is or is not in operation. Even if the aerodynamic rotor is thus no longer turning the wind energy plant, and the wind energy plant is producing no current, more particularly because it is no longer generating any power for reasons of storm security, it is nevertheless turned into the wind and also correspondingly tracking the wind.

Such an alignment of the wind energy plant preferably takes place with its azimuth position into the wind whilst the rotor blades are in the feathered position.

The wind energy plant is preferably aligned with its azimuth position into the wind and is tracking the wind particularly in the event of a storm, wherein the power required for this is provided by an energy accumulator if no or insufficient power can be drawn from the electric supply network and/or the generator. This thus relates in particular to the situation where the wind energy plant is no longer in a productive operating mode. This includes the situation where for its own protection the wind energy plant is no longer operating on account of wind speeds which are too high. This however also includes a situation in which for reasons of the network protection the wind energy plant no longer feeds into the network, more particularly is also no longer connected to the network. This also includes the situation where the wind energy plant is already fully erected but its initial operation has not however yet taken place.

It is accordingly proposed to align the wind energy plant into the wind in each case, at least in storm situations when a 50-year gust cannot be ruled out. So that this can thus also be guaranteed in all circumstances it is proposed to undertake this where necessary by means of energy from an energy accumulator.

According to one embodiment a method is proposed characterized in that at least one measuring apparatus for detecting a wind direction is provided on the wind energy plant and the at least one measuring apparatus for detecting the wind direction is operated even in the event of a storm when the occurrence of a 50-year gust cannot be ruled out, or more particularly is probable. A constant operation of the measuring apparatus for determining the wind direction is thus proposed so that for the wind energy plant, even if it is not feeding any power into the network, the wind direction is known and therefore the direction is known from which the 50-year gust may also be expected. The measuring apparatus is preferably operated via an electric energy accumulator so that it can also be operated if a network failure occurs. A severe storm can also be the cause for a network failure.

An additional measuring apparatus is preferably provided as a redundance measuring apparatus for detecting the wind direction. The wind energy plant can thus also still detect the wind direction in the event of a failure of one of the measuring apparatuses and where application can align the wind energy plant so that the 50-year gust does not strike the plant from an unfavorable direction. At least two measuring apparatuses are preferably hereby provided for detecting the wind direction, and they are arranged at such a distance from one another and operated so that they are not always covered by a rotor blade at the same time. Thus at least one of the measuring apparatuses can always adequately detect the wind direction.

These methods proposed for operating the wind energy plant are preferably used for a wind energy plant which was designed according to one of the methods described above for designing a wind energy plant. More advantageously these two methods interact with one another. Namely the wind energy plant is accordingly first designed slender as described and then is operated with a method which observes the conditions used as a basis for the design. However even without such a design the proposed method for operating the wind energy plant can lead to a reduction on the load.

According to one configuration it is proposed that at least one wind direction information from at least a further wind energy plant is used to align the wind energy plant into the wind. This proposal is particularly advantageous in the event of a wind farm, but can however also be expedient for several wind energy plants which are close together but not organized into one farm, thus more particularly use no common feed-in point. Particularly in the case of storm conditions which are relevant here, measuring the wind direction is also not quite so easy or quite so precise as in the case of weak laminar winds. Thus the information situation can be improved by using further wind direction information from other neighboring wind energy plants or wind energy plants of the same wind farm. Changes in the wind direction can furthermore be recognized more quickly where applicable by using further wind direction information from other wind energy plants. Thus where applicable a local variation of the wind direction may also exist over the wind farm. Such a local variation of the wind direction can also be taken into consideration and the wind energy plants can be adapted in their alignment thereto when the occasion arises.

A wind direction can be formed by way of example from mean wind direction measurements. If however by evaluating diverse wind directions of the wind energy plants of the farm it is established that a local variation of the wind direction is present over the wind farm, averaging out the wind direction values over the entire farm would not be appropriate. Instead of this the wind direction in each case from a wind direction distribution thus detected can be used for the relevant wind energy plant. Other possibilities are also to use the values of the wind directions of several wind energy plants which are standing one behind the other in relation to the wind.

It is preferably proposed that in the event of a storm the wind energy plant is aligned with its rotor so that a rotor blade is in a 6 o'clock position and/or that the rotor can rotate freely about its rotor rotational axis. It was recognized that more advantageously a very high load can be avoided particularly if a 12 o'clock position of a rotor blade is avoided. In the case of a 12 o'clock position the relevant rotor blade thus reaches the maximum height which is possible. The wind speeds however increase with the height and thus would thereby provide the maximum load, with otherwise identical comparison parameters. If a rotor blade is turned into the 6 o'clock position, then the 10 o'clock and the 2 o'clock position of the two remaining rotor blades of a 3-blade wind energy plant still remain as the highest positions.

Load relief can however also be brought about in that the rotor is not fixed in one position but it is possible to freely rotate it. If now particular loads occur on the rotor blade then the rotor blade can yield at least in part to this load if the rotor is thereby turned a little. It is particularly preferred to guide the wind energy plant as far as possible into a position with a rotor blade in the 6 o'clock position, to thereby nevertheless allow the free rotation of the rotor. This would be possible by way of example by a corresponding minimal pitch adjustment of a rotor blade, more particularly the lower rotor blade in the 6 o'clock position or in the practically 6 o'clock position. The other two rotor blades could then remain in the position which can anticipate the lowest load. The lower of the rotor blades would in any case be exposed to less stress.

The low load of the rotor blade in the 6 o'clock position is based on the one hand on the fact that the wind speeds are lower at lowest heights. It is however also based on the fact that a tower screen leads to a load relief. The effects of a tower screen against the wind moreover also occur when the relevant blade is on the windward side of the tower, thus from the wind direction in front of the tower. Furthermore the risk of the blade touching the tower is not to be anticipated particularly in the case of aligning the rotor blade in the feathered position.

According to the invention a wind energy plant according to claim 13 is also proposed which has a generator and a rotor with rotor blades and which was designed according to a design method described above. Furthermore or as an alternative the wind energy plant is characterized in that it is operated according to one of the methods described above for operating a wind energy plant. More particularly this wind energy plant has been designed slender as described, namely for a reduced maximum load, and it is prepared, more particularly by a correspondingly provided and implemented control, to observe the conditions on which the design is based.

A wind farm is also proposed according to claim 15 which has several wind energy plants according to the invention.

### BRIEF DESCRIPTION OF THE SEVERAL VIEWS OF THE DRAWINGS

The invention will now be explained in further detail with reference to embodiments by way of example with reference to the accompanying figures in which

FIG. 1 shows a wind energy plant diagrammatically in a perspective view;

FIG. 2 shows a wind farm in a diagrammatic illustration;

FIG. 3 shows a plan view of a wind energy plant nacelle in a diagrammatic and simplified illustration to indicate the direction of a possible wind attack;

FIG. 4 shows on a diagrammatic load curve B possible load fluctuations in dependence on the attack direction of the wind.

### DETAILED DESCRIPTION

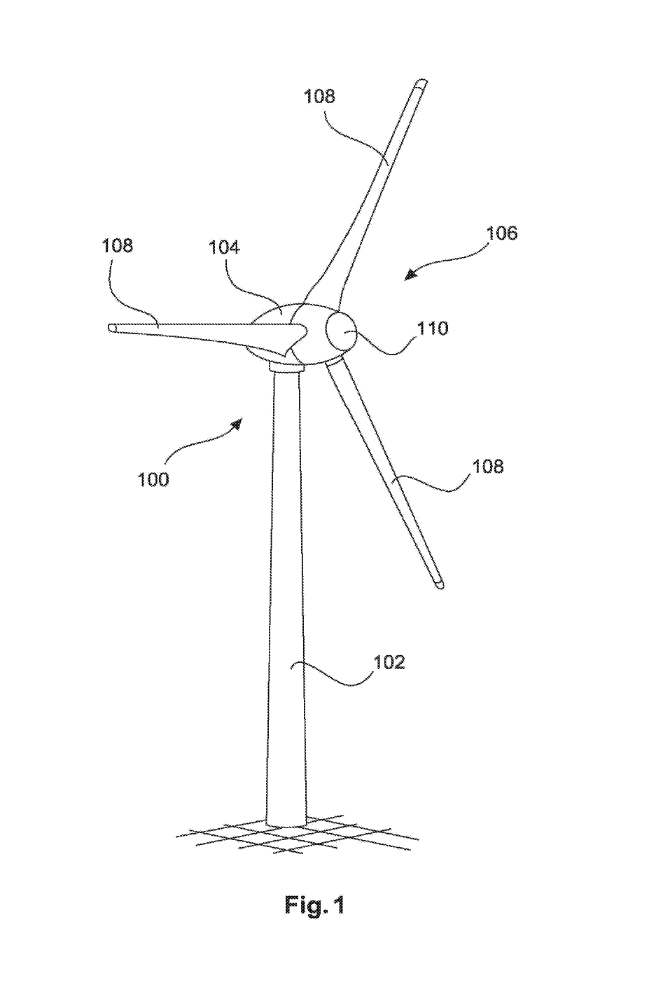

FIG. 1 shows a wind energy plant 100 with a tower 102 and a nacelle 104. A rotor 106 is arranged with three rotor blades 108 and a spinner 110 on the nacelle 104. The rotor 106 is set in operation in rotational movement by the wind and thereby drives a generator in the nacelle 104.

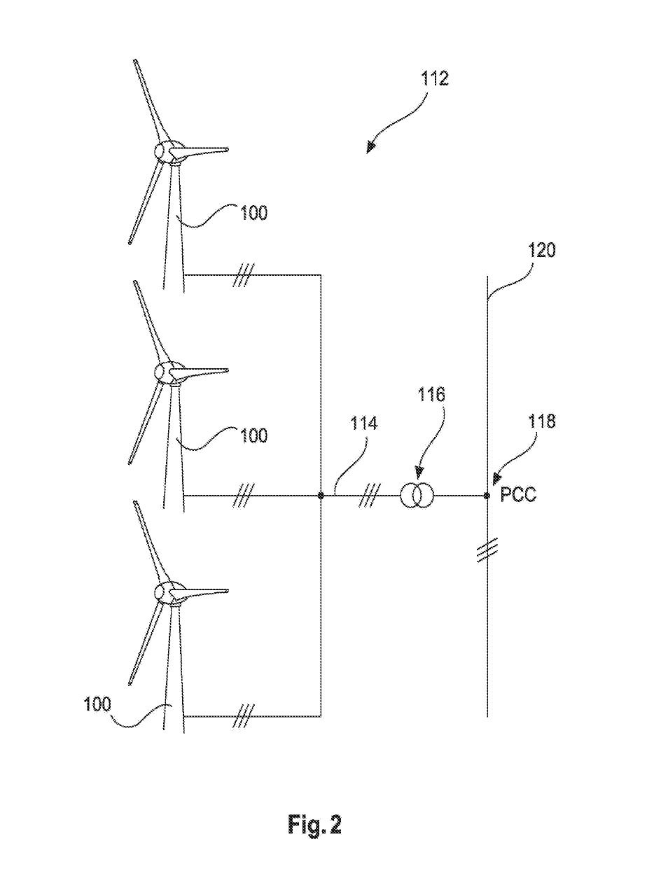

FIG. 2 shows a wind farm 112 with by way of example three wind energy plants 100 which can be the same or different. The three wind energy plants 100 are thus representative of the basically any number of wind energy plants of a wind farm 112. The wind energy plants 100 supply their power, namely in particular the generated current, via an electric farm network 114. The currents or power capacities each produced by the individual wind energy plants 100 are thereby added up and mostly a transformer 116 is provided which transforms the voltage in the farm, in order then to feed it into the supply network 120 at the feed-in point 118 which is also generally termed a PCC. FIG. 2 shows only a simplified illustration of a wind farm 112 which shows by way of example no control system, although naturally a control system is present. Also by way of example the farm network 114 can be configured differently in which by way of example a transformer is also provided at the output of each wind energy plant 100, in order only to quote another exemplary embodiment.

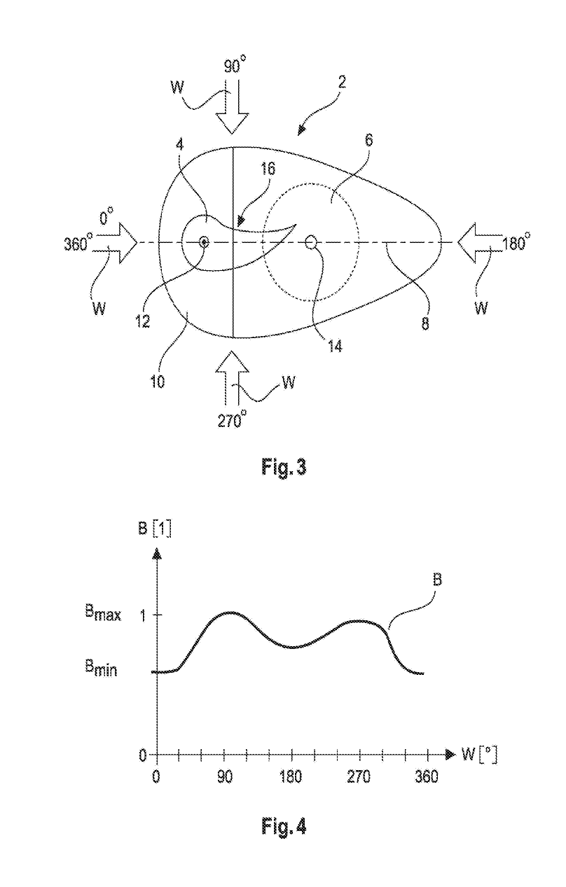

FIG. 3 shows of a wind energy plant in a diagrammatic plan view a nacelle 2 and a rotor blade 4 indicated in its prepared outline as well as an outline of a tower 6 shown in dotted lines in its upper region. As shown in FIGS. 1 and 2 it basically starts from a wind energy plant with three rotor blades. Thus in FIG. 3 in addition to the rotor blade 4, which here is shown in a 12 o'clock position, two further rotor blades would be seen, namely in the 4 o'clock position and 8 o'clock position. For simplification these two rotor blades are however omitted. The illustrated rotor blade is thus arranged together with the illustrated spinner 10 rotatable about the horizontal rotor rotational axis 8.

Furthermore the rotor blade 4 is adjustable about the pitch axis 12, shown only as a point, in its set-up angle to the wind. FIG. 3 shows thus far a feathered position of the rotor blade 4. It is thereby to be noted that FIG. 3 is a diagrammatic illustration which for simplification of the illustration does not go into the usual torsion of the rotor blade. The illustrated section of the rotor blade 4 is thus to illustrate the feathered position representative for the entire rotor blade 4.

The illustrated nacelle 2 is furthermore displaceable about a vertical azimuth axis 14 so that the nacelle can be aligned in a desired position relative to the wind.

FIG. 3 shows symbolically four possible wind directions W which are drawn in here for four directions, namely 0°, 90°, 180° and 270°. Naturally all the intermediate directions are also possible. These wind directions W relate in this illustration to the aligned nacelle 2 and thus to the alignment of the rotor rotational axis 8. This relative alignment of the wind direction W in relation to the nacelle also forms the basis of the illustration of FIG. 4 which will be explained below.

FIG. 3 now shows a preferred alignment of the wind energy plant with its nacelle 2 for the case where the wind direction amounts to 0° as drawn. This preferred embodiment also has the rotor blades 4 in the feathered position, as is indicated for the example of the rotor blade 4.

The three further wind directions which have been drawn in, namely 90°, 180° and 270°, represent the wind directions or alignments of the nacelle 2, which are thus not desired.

Particularly for the wind direction W at 90° a large attack surface is produced for the nacelle 2 on account of the lateral flow. Furthermore the wind here flows onto the pressure side 16 of the rotor blade 4. It should in any case be noted that FIG. 3 is only for illustration and it is particularly preferred if the wind energy plant is provided with one rotor blade in the 6 o'clock position and the other two rotor blades are in the 10 o'clock and 2 o'clock position respectively.

It hereby arises that the opposite passing flow, namely at 270°, also as a whole means the load for the wind energy plant is not much smaller.

FIG. 3 thus also shows the wind direction W at 180°, thus for wind which attacks the nacelle from behind. Such load ought indeed be lower than a load from side wind, because the attack face on the nacelle is also lower than in the case of a side wind, but the wind energy plant is basically designed for wind from the front, thus wind at 0° or 360° according to FIG. 3. By way of example the illustrated feathered position of the rotor blade 4 is also more favorable for wind with wind direction W of 0° or 360° respectively, than for a wind direction W of 180°.

FIG. 4 shows a load curve B which is to depict a possible load curve in dependence on the wind direction W. The wind direction W which is entered with corresponding degrees on the abscissa is used for understanding FIG. 3. 0° and 360° respectively is thus a wind direction from the front on the nacelle 2 or the spinner 10.

FIG. 4 now shows, where the curve represents a simplified path, that a minimum load Bₘᵢₙ, exists at 0° and 360° respectively. A maximum load is assumed at 90° and a similarly high, only slightly less load is assumed at 270°. At 180° the load is lower, but in any case greater than the minimum load at 0°.

The illustrative curve of FIG. 4 thereby has standardized the load at a load value of Bₘᵢₙ. The maximum load Bₘₐₓ is thus set at one.

It is now proposed to design the wind energy plant not for the load Bₘₐₓ, but for the reduced load of Bₘᵢₙ.

There are many possibilities for including such a load on the wind energy plant. One possibility consists in using the forces which occur at a load-critical point. Such forces can be taken up and integrated from several critical points, thus by way of example a blade root, a tower head, a tower foot and an axle pivot fastening. The illustration of FIG. 4 is the basis of one such consideration.

In the case of the actual design it would then naturally be ensured that each individual critical point is not loaded beyond its load limit even in the event of a 50-year gust. For selecting the underlying marginal conditions where the reduced maximum load occurs it is expedient to consider one such integrating illustration according to FIG. 4. Finally these marginal conditions, thus in particular the alignment of the nacelle, the rotor and the rotor blades, must then be the basis for each of the critical components or investigated points.

1. A method comprising:
designing a wind energy plant with a generator and a rotor with rotor blades, wherein designing comprises:
determining the size a rotor diameter and an axle height of the wind energy plant for a proposed installation site, and
determining a maximum load based on a 50-year gust strike for the proposed installation site when the wind strikes the wind energy plant from a side or a backside, wherein the rotor diameter and the axle height are of sizes to withstand only up to a reduced maximum load that is less than the maximum load; and
installing the wind energy plant at the proposed installation site.

2. The method according to claim 1 wherein the reduced maximum load is a load which occurs when the 50-year gust strikes the wind energy plant from a direction which leads to a minimal load on the wind energy plant.

3. The method according to claim 1 wherein the reduced maximum load is a load which occurs when the 50-year gust strikes the wind energy plant from a front side of the wind energy plant and when the rotor blades are displaceable rotor blades and the rotor blades are in the feathered position.

4. The method according to claim 1 wherein the reduced maximum load is a load which occurs when the 50-year gust strikes the wind energy plant substantially from a front side of the wind energy plant that includes a region of +/−20° from a rotational axis of the rotor.

5. The method according to claim 1 further comprising determining a dimension of a nacelle, a dimension of a tower, a dimension of a tower foundation, and dimensions for rotor blades for the proposed installation site, wherein dimension of the nacelle, the dimension of the tower, the dimension of the tower foundation, and dimensions for rotor blades are sized to withstand only up to a reduced maximum load that is less than the maximum load.

6. A method comprising:
operating a wind energy plant;
detecting a wind above a threshold value; and
aligning the wind energy plant so that its azimuth position faces into the wind to thereby provide to a reduced maximum load applied to the wind energy plant by the wind than when a side of the wind energy plant faces into the wind.

7. The method according to claim 6 further comprising repeatedly aligning the azimuth position of the wind energy plant into the wind as a direction of the wind changes over time.

8. The method according to claim 7 wherein repeatedly aligning the azimuth position comprises using power required from an energy accumulator when there is no or no sufficient power to be drawn from at least one of the electric supply network and the generator.

9. The method according to claim 6 wherein aligning the wind energy plant comprises rotating a nacelle of the wind energy plant so that a spinner of the nacelle substantially faces into a prevailing direction of the wind.

10. Method according to claim 6 further comprising stopping the wind energy plant from operating.

11. The method according to claim 6 further comprising detecting a wind direction, wherein aligning the wind energy plant so that its azimuth position faces into the wind is based on the detected wind direction.

12. The method according to claim 6 further comprising:
rotating the rotor so that a rotor blade coupled to the rotor is in a 6 o'clock position; and
allowing the rotor to freely rotate about its rotor rotational axis.

13. A wind energy plant located in a wind farm that has a 50-year wind gust, the energy plant comprising:
a tower;
a nacelle;
a generator in the nacelle; and
a rotor rotatably coupled to the nacelle, a plurality of rotor blades coupled to the rotor,
wherein a rotor diameter and an axle height of the wind energy plant are sized to withstand the 50-year wind gust when a front face of the rotor is substantially facing into the wind and is not sized to withstand the 50-year wind gust when a side of the rotor is facing into the wind.

14. The wind energy plant according to claim 13 comprising at least one measuring apparatus for detecting a wind direction and is configured to be operated by an electric energy accumulator.

15. A wind farm comprising at least two wind energy plants according to claim 13.

16. The wind energy plant according to claim 13 wherein at least two measuring apparatuses are each provided on the wind energy plant for detecting a wind direction.

17. The method according to claim 9 wherein the spinner of the nacelle substantially faces into the prevailing direction of the wind when the prevailing direction of the wind is in a region of +/−20° from a rotational axis of the rotor.

18. The method according to claim 11 wherein the wind energy plant is a first wind energy plant, wherein detecting the wind direction is performed at a second wind energy plant, wherein the first and second wind energy plants are located in a wind farm.
